(19) United States
(12) Patent Application Publication
(10) Pub. No.: US 2026/0227075 A1
(43) Pub. Date: Aug. 6, 2026

(54) SHELL ASSEMBLY, COOKING APPARATUS AND COOKING SYSTEM

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Wenjie FAN, Foshan (CN); Modam JOO, Foshan (CN); Minghua HONG, Foshan (CN)

(21) Appl. No.: 19/574,092

(22) Filed: Mar. 20, 2026

Related U.S. Application Data
(63) Continuation of application No. PCT/CN2023/132415, filed on Nov. 17, 2023.

(30) Foreign Application Priority Data
Sep. 21, 2023 (CN) 202322582281.3

(51) Int. Cl. F24C 15/08; F24C 15/00; F24C 15/12

(52) U.S. Cl. CPC F24C 15/08; F24C 15/007; F24C 15/12

(57) ABSTRACT

Provided are a shell assembly, a cooking apparatus, and a cooking system. The shell assembly includes a shell. The shell defines a receiving space and includes a top plate and a mounting plate. The mounting plate extends obliquely downwards relative to a first plane where the top plate is located. The mounting plate has a cord-fixing groove for accommodating a power cord.

### CROSS-REFERENCE TO RELATED APPLICATION

This application is a continuation application of International (PCT) Patent Application No. PCT/CN2023/132415, filed on November 17, 2023, which claims priority to Chinese Patent Application No. 202322582281.3, titled “SHELL ASSEMBLY, COOKING APPARATUS AND COOKING SYSTEM”, and filed on September 21, 2023, the entire disclosure of which is incorporated herein by reference.

### FIELD

The present disclosure relates to the field of cooking appliances, and particularly, to a shell assembly, a cooking apparatus, and a cooking system.

### BACKGROUND

When a built-in cooking apparatus is mounted in a kitchen cabinet, a protruding power cord occupies a separate part of a cabinet space. As a result, the built-in cooking apparatus may not be fit flush against an inner surface of the cabinet, and may lead to a waste of space.

### SUMMARY

The present disclosure provides a shell assembly to improve a space utilization rate.

For a shell assembly according to embodiments of the present disclosure, the shell assembly includes a shell. The shell defines a receiving space and includes a top plate and a mounting plate. The mounting plate extends obliquely downwards relative to a first plane where the top plate is located. The mounting plate has a cord-fixing groove for receiving a power cord.

For the shell assembly according to the embodiments of the present disclosure, by providing the mounting plate that extends obliquely downwards, the shell assembly can fit flush against an inner surface of a cabinet, thereby improving the space utilization rate. Meanwhile, a volume of the receiving space is increased, and the receiving space can thus receive more devices or food.

Optionally, the shell further includes a rear plate directly facing an opening of the receiving space. The mounting plate is connected between the top plate and the rear plate.

Optionally, the shell further includes a left side plate and a right side plate. Two ends of the mounting plate are connected to the left side plate and the right side plate, respectively.

Optionally, the mounting plate is formed as a flat plate extending obliquely downwards.

Optionally, the shell assembly further includes a fixing support mounted to the mounting plate. The cord-fixing groove is formed in the fixing support.

Optionally, the fixing support has a notch in communication with the cord-fixing groove. The power cord is adapted to be inserted into the cord-fixing groove through the notch.

Optionally, the notch has a guide surface extending obliquely towards an interior of the cord-fixing groove.

Optionally, a plurality of fixing supports are provided and arranged at intervals in a length direction of the mounting plate.

Optionally, the mounting plate has a cord passage hole for the power cord. The cord passage hole is formed at an end of the mounting plate in the length direction of the mounting plate, and the plurality of fixing supports are sequentially arranged in a direction away from the mounting hole.

Optionally, the mounting plate has a first mounting groove and a second mounting groove. The first mounting groove has a different opening direction from the second mounting groove. The fixing support is provided with a first mounting portion and a second mounting portion. The first mounting portion extends into the first mounting groove, and the second mounting portion extends into the second mounting groove.

Optionally, an opening of the first mounting groove faces rearwards; and an opening of the second mounting groove faces upwards.

A cooking apparatus according to embodiments of the present disclosure includes the shell assembly described above.

For the cooking apparatus according embodiments of the present disclosure, by providing the mounting plate that extends obliquely downwards, the shell assembly can fit flush against the inner surface of the cabinet, thereby improving the space utilization rate. Meanwhile, the volume of the receiving space is increased, and the receiving space can thus receive more devices or food.

Optionally, the shell has a food access opening; and the cooking apparatus further includes a drawer assembly. A food carrying space is formed in the drawer assembly, and the drawer assembly is drawably disposed in the receiving space through the food access opening.

Optionally, the cooking apparatus further includes an inner container having a cooking space. The shell has an air inlet and an air outlet, and an airflow channel is formed between the shell and an outer side wall of the inner container. The airflow channel is in communication with each of the air inlet and the air outlet. The cooking space has a first air inlet hole in communication with the airflow channel. The cooking apparatus further includes a third fan located within the airflow channel.

Optionally, the inner container has an air inlet region, a return air region, and a microwave inlet on a top wall of the inner container. At least part of the microwave inlet directly faces the air inlet region in a left-right direction. The cooking apparatus further includes an air duct member and a first fan. An air duct member is disposed between the top wall of the inner container and the shell. An air duct space is defined between the air duct member and the top wall of the inner container. The air inlet region and the return air region are located in the air duct space. The first fan is located in the air duct space.

Optionally, the air inlet is located below the inner container; the air outlet is located above the inner container; and the airflow channel includes a bottom airflow passage, a rear airflow passage, and a top airflow passage. The bottom airflow passage is located at a bottom of the inner container and in communication with the air inlet. An upper end and a lower end of the rear airflow passage are in communication with the top airflow passage and the bottom airflow passage, respectively. The top airflow passage is in communication with the air outlet. The third fan is located in the rear airflow passage. The air duct member is disposed in the top airflow passage.

Optionally, the cooking apparatus is constructed as a built-in cooking apparatus.

A cooking system according to embodiments of the present disclosure includes the cooking apparatus described above and a cabinet. The cabinet has an accommodation cavity for accommodating the cooking apparatus.

For the cooking system according to the embodiments of the present disclosure, by providing the mounting plate that extends obliquely downwards, the shell assembly can fit flush against the inner surface of the cabinet, thereby improving the space utilization rate. Meanwhile, the volume of the receiving space is increased, and the receiving space can thus receive more devices or food.

Additional aspects and advantages of the embodiments of the present disclosure will be provided at least in part in the following description, or will become apparent in part from the following description, or can be learned from the practice of the embodiments of the present disclosure.

### BRIEF DESCRIPTION OF THEDRAWINGS

These and other aspects and advantages of embodiments of the present disclosure will become apparent and more readily appreciated from the following descriptions made with reference to the accompanying drawings.

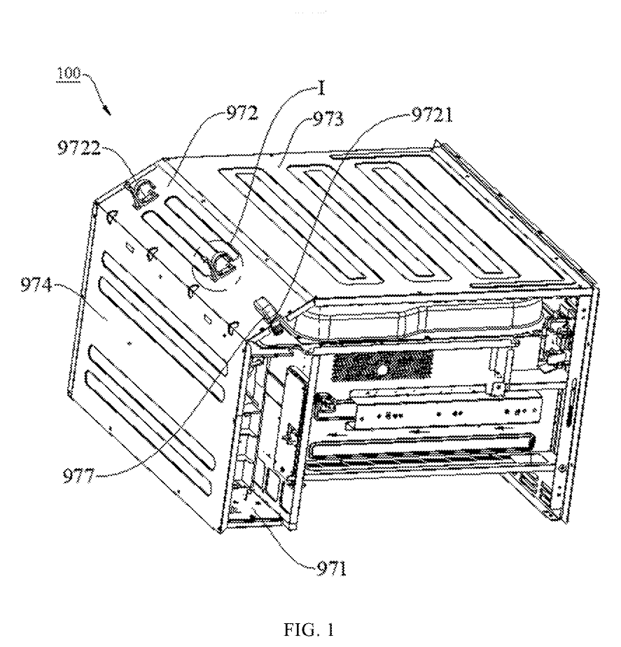

FIG. 1 is a schematic view of a relative position of a power cord and a fixing support according to some embodiments of the present disclosure.

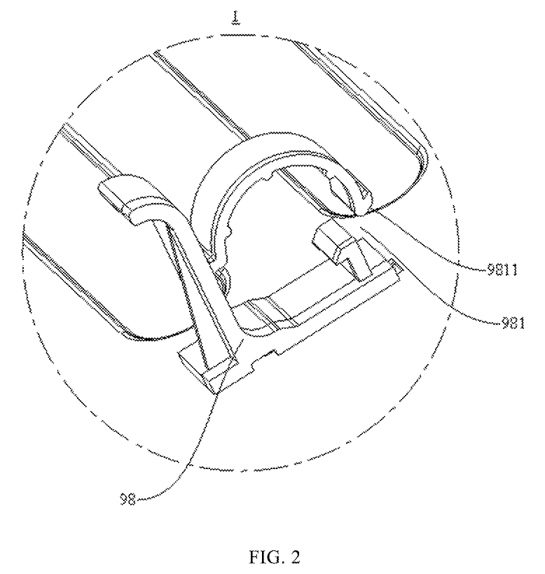

FIG. 2 is a partial enlarged view of part I in FIG. 1.

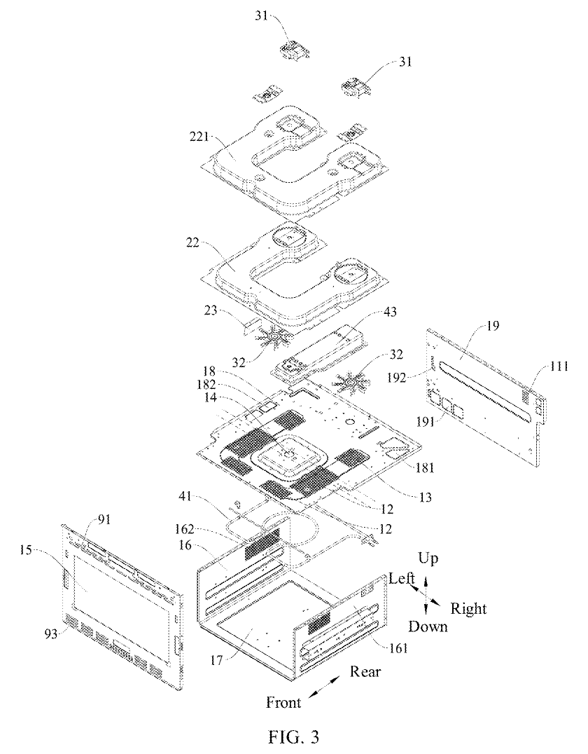

FIG. 3 is a first exploded view of a partial structure of a cooking apparatus according to some embodiments of the present disclosure.

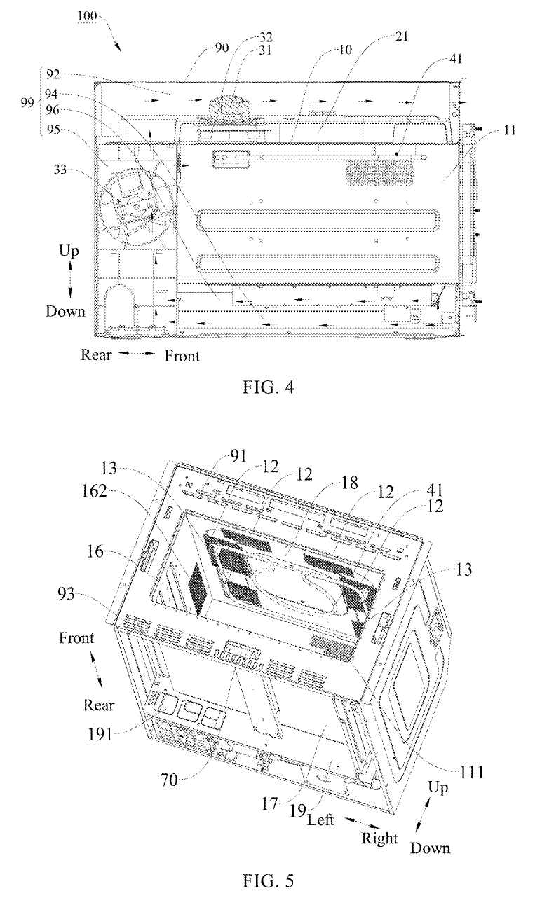

FIG. 4 is a cross-sectional view of a cooking apparatus according to some embodiments of the present disclosure.

FIG. 5 is a first schematic view of a partial structure of a cooking apparatus according to some embodiments of the present disclosure.

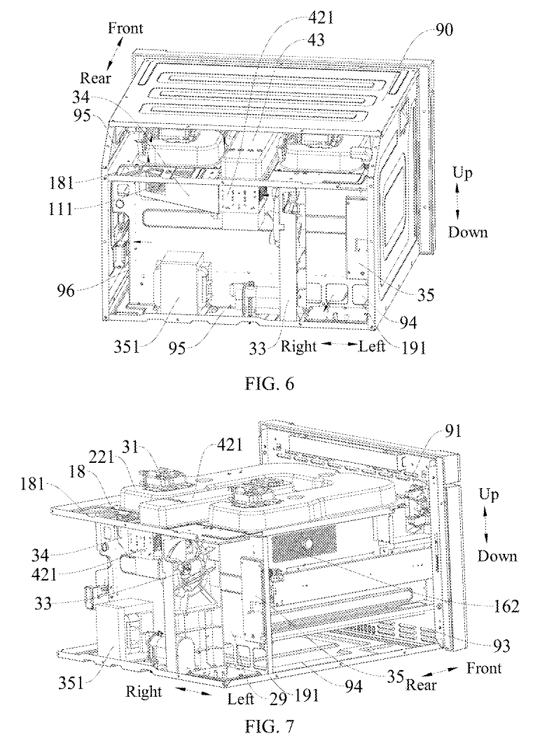

FIG. 6 is a first schematic view of a partial structure of a cooking apparatus according to some embodiments of the present disclosure.

FIG. 7 is a second schematic view of a partial structure of a cooking apparatus according to some embodiments of the present disclosure.

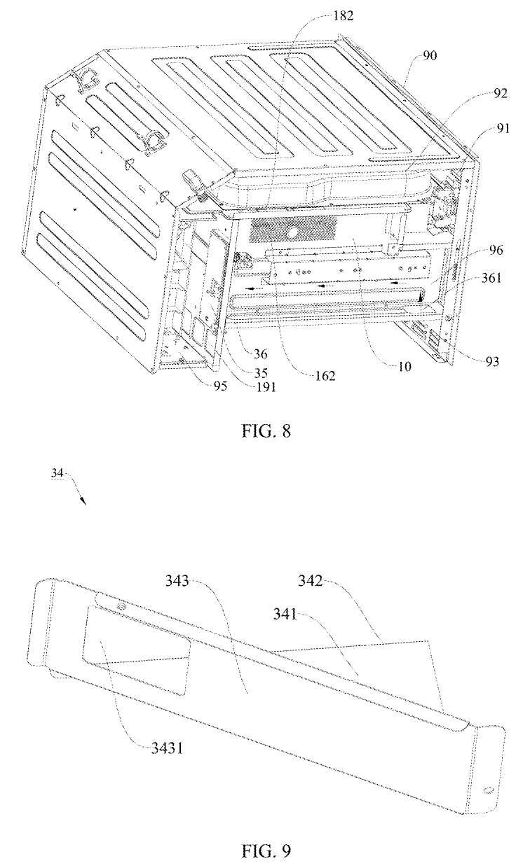

FIG. 8 is a third schematic view of a partial structure of a cooking apparatus according to some embodiments of the present disclosure.

FIG. 9 is a schematic structural view of a first air guide hood according to some embodiments of the present disclosure.

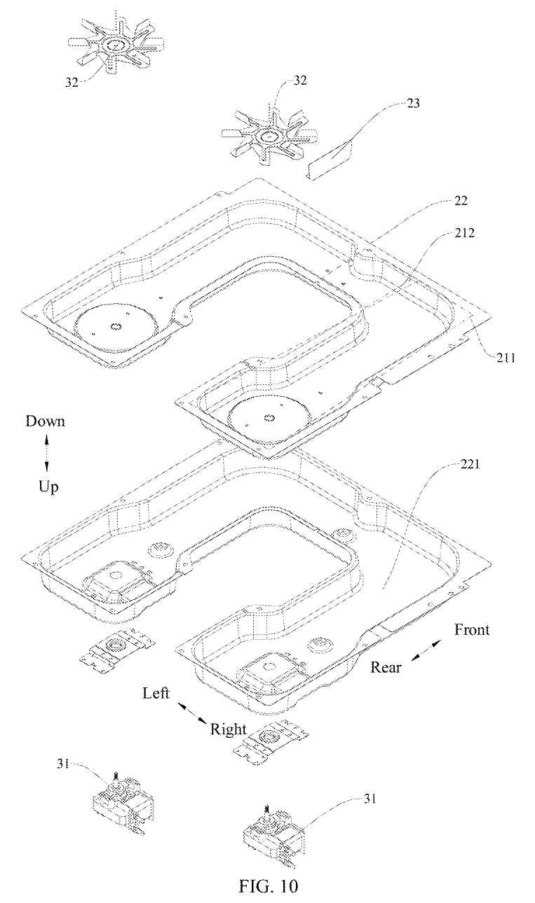

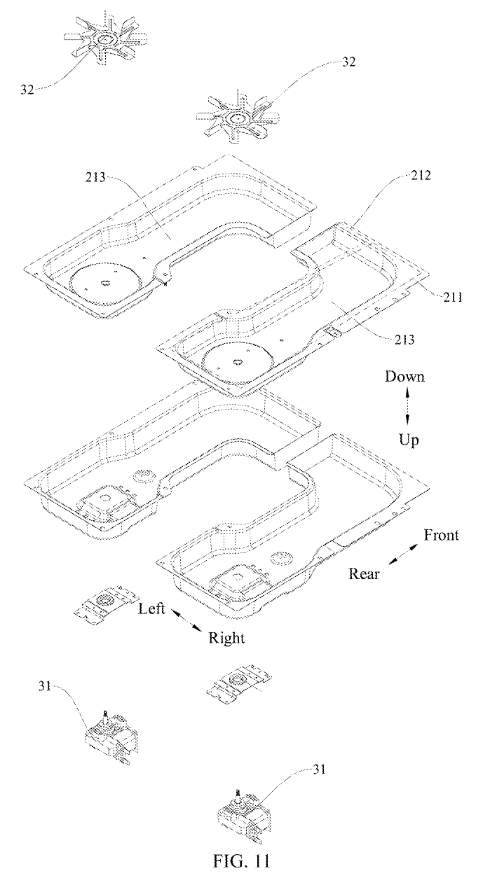

FIG. 10 is an exploded view of a first fan assembly according to some embodiments of the present disclosure.

FIG. 11 is an exploded view of a first fan assembly according to some embodiments of the present disclosure.

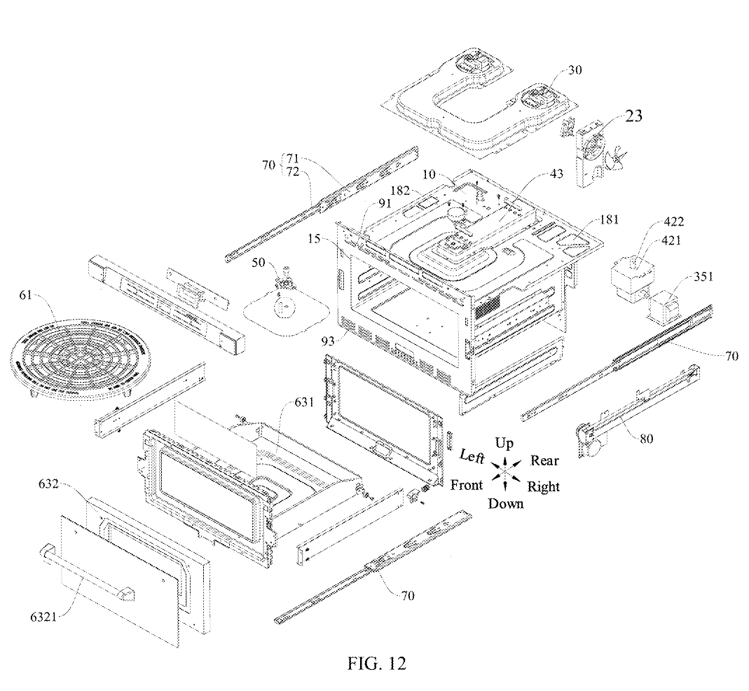

FIG. 12 is a second exploded view of a partial structure of a cooking apparatus according to some embodiments of the present disclosure.

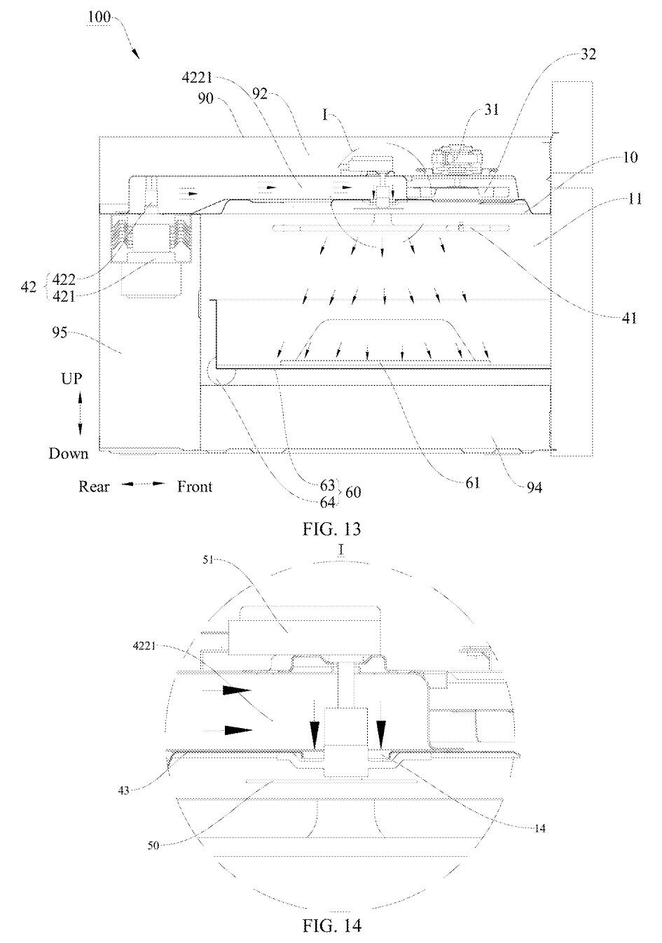

FIG. 13 is a schematic view of a microwave flow direction according to some embodiments of the present disclosure.

FIG. 14 is a partial enlarged view of part II in FIG. 13.

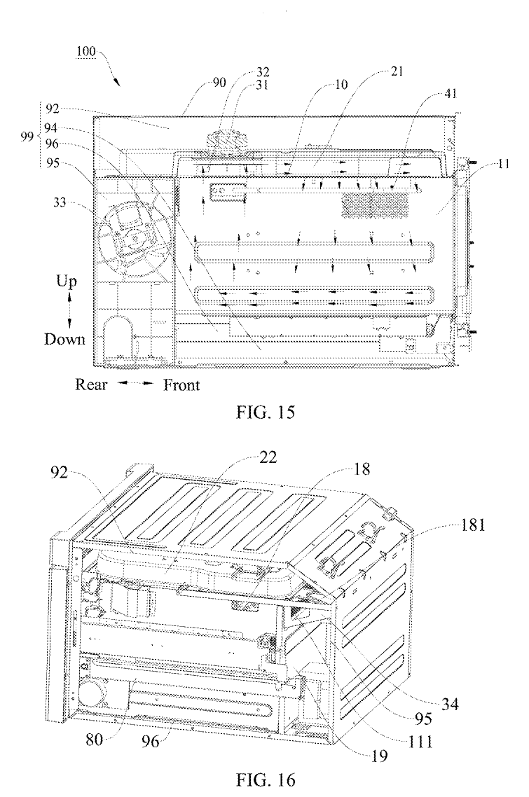

FIG. 15 is a schematic view of airflow circulation in a cooking space according to some embodiments of the present disclosure.

FIG. 16 is a fourth schematic view of a partial structure of a cooking apparatus according to some embodiments of the present disclosure.

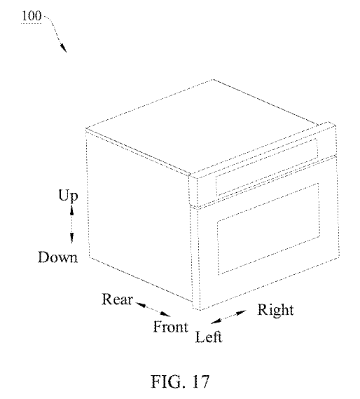

FIG. 17 is a schematic view of a cooking apparatus according to some embodiments of the present disclosure.

### Reference numerals:

100, cooking apparatus;

10, inner container; 11, cooking space; 111, first air inlet hole; 12, air inlet region; 13, air return region; 14, microwave inlet; 15, food access opening; 16, first side plate; 161, second side plate; 162, heat dissipation area; 17, bottom plate; 18, inner container upper plate; 181, third air inlet hole; 182, fourth air inlet hole; 19, inner container rear plate; 191, first communication hole; 192, second communication hole;

21, air duct space; 211, first part; 212, second part; 213, subspace; 22, air duct member; 221, heat shield; 23, partition member;

31, first motor; 32, first fan; 33, third fan; 34, first air guide hood; 341, air guide channel; 342, air guide bottom plate; 343, air guide connection plate; 3431, air outlet hole; 35, control module; 351, transformer; 36, air baffle plate; 361, second air inlet hole;

41, heating tube; 42, microwave assembly; 421, microwave generator; 422, waveguide; 4221, guide channel; 43, tubular metallic member;

50, second fan; 51, stirring motor;

60, drawer assembly; 61, food carrier; 63, drawer main body; 631, drawer body; 632, drawer door; 6321, handle; 64, roller;

70, guide rail assembly; 71, guide rail; 72, slider; 80, drawer driver;

90, shell; 91, air outlet; 92, top airflow passage; 93, air inlet; 94, bottom airflow passage; 95, rear airflow passage; 96, side airflow passage; 971, receiving space; 972, mounting plate; 9721, cord passage hole; 9722, cord-fixing groove; 973, top plate; 974, rear plate; 975, left side plate; 975, right side plate; 977, power cord; 98, fixing support; 981, notch; 9811, guide surface; 99, airflow channel.

### DETAILED DESCRIPTION OF THE EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain rather than limit the present disclosure.

A shell assembly for a cooking apparatus according to embodiments of the present disclosure will be described below with reference to the accompanying drawings.

As shown in FIG. 1 and FIG. 2, for the shell assembly for the cooking apparatus according to the embodiments of the present disclosure, the shell assembly for the cooking apparatus includes a shell 90. The shell 90 defines a receiving space 971 and includes a top plate 973 and a mounting plate 972. The mounting plate 972 extends obliquely downwards relative to a first plane where the top plate 973 is located. The mounting plate 972 has a cord-fixing groove 9722 for receiving a power cord 977.

For example, the mounting plate 972 has a cord passage hole 9721 for the power cord 977. The cord passage hole 9721 on the mounting plate 972 is configured to avoid the power cord 977, and the power cord 977 passes through the cord passage hole 9721. In some embodiments, the cord passage hole 9721 for the power cord 977 is formed on other surfaces of the shell 90, such as a surface of a top plate or a surface of a side plate, and the power cord 977 may still be fixed in the cord-fixing groove 9722.

The mounting plate 972 extends obliquely downwards relative to the first plane where the top plate 973 is located. The mounting plate 972 may either be connected to the top plate 973 and extend obliquely downwards relative to the first plane, or be connected to a bottom plate 17 of the shell 90 and extend obliquely downwards relative to the first plane.

For example, the cord-fixing groove 9722 for receiving the power cord 977 is formed at an outer surface of the mounting plate 972. The power cord 977 is stably fixed on the shell 90 by means of the cord-fixing groove 9722. For example, the power cord 977 is wrapped around the cord-fixing groove 9722 or is connected to the cord-fixing groove 9722 through interference fit.

In the related art, when a built-in cooking apparatus is mounted in a cabinet, a protruding power cord occupies a separate part of a cabinet space. As a result, the built-in cooking apparatus cannot fit flush against an inner surface of the cabinet, leading to a waste of space. In the present disclosure, by providing the mounting plate 972 extending obliquely, the shell assembly fits flush against the inner surface of the cabinet, thereby improving a space utilization rate.

Meanwhile, the mounting plate 972 extends obliquely downwards relative to the first plane where the top plate 973 is located. Compared with a solution in which the cooking apparatus has a horizontal mounting surface at a shell of the cooking apparatus separately, the mounting plate 972 extending obliquely downwards in the present disclosure makes the receiving space 971 larger, and the receiving space 971 can thus receive more devices or food.

For the shell assembly for the cooking apparatus according to the embodiments of the present disclosure, by providing the mounting plate 972 that extends obliquely downwards, the shell assembly can fit flush against the inner surface of the cabinet, thereby improving the space utilization rate. Meanwhile, a volume of the receiving space 971 is increased, and the receiving space 971 can thus receive more devices or food.

As shown in FIG. 1 and FIG. 2, in some embodiments, the shell 90 further includes a rear plate 974 directly facing an opening of the receiving space 971. The mounting plate 972 is connected between the top plate 973 and the rear plate 974. By connecting the mounting plate 972 between the top plate 973 and the rear plate 974, the power cord 977 is located in a relatively high position, making it convenient for a user to access, plug and unplug the power cord 977.

In some embodiments, an auxiliary plate is further provided between the mounting plate 972 and the top plate 973 or the rear plate 974, and a predetermined angle is formed between the auxiliary plate and the mounting plate 972. For example, the auxiliary plate is parallel to the rear plate 974 and has an end edge connected to the mounting plate 972 and another end edge connected to the top plate 973; or the auxiliary plate is parallel to the top plate 973 and has an end edge connected to the mounting plate 972 and another end edge connected to the rear plate 974.

In some other embodiments, the shell 90 further includes a bottom plate 17 and a rear plate 974. The bottom plate 17 is opposite to the top plate 973. The rear plate 974 is directly facing an opening of the receiving space 971. The mounting plate 972 is connected between the bottom plate 17 and the rear plate 974.

In some embodiments, the shell 90 further includes a left side plate and a right side plate. Two ends of the mounting plate 972 are connected to the left side plate and the right side plate, respectively. By configuring the two ends of the mounting plate 972 to be respectively connected to the left side plate and the right side plate, the mounting plate 972 is located at a corner of the shell 90, and a reserved space can receive a longer power cord 977.

In some other embodiments, the shell 90 further includes a left side plate and a right side plate. The mounting plate 972 has an end connected to one of the left side plate and the right side plate, and a reserved space can receive a power cord 977 of a suitable length.

As shown in FIG. 1 and FIG. 2, in some embodiments, the mounting plate 972 is formed as a flat plate extending obliquely downwards. By configuring the mounting plate 972 as the flat plate extending obliquely downwards, production and manufacturing are facilitated.

In some other embodiments, the mounting plate 972 is formed as a curved plate extending obliquely downwards to fully utilize the space.

As shown in FIG. 1 and FIG. 2, in some embodiments, the shell assembly further includes a fixing support 98 mounted to the mounting plate 972. The cord-fixing groove 9722 is formed in the fixing support 98. By providing the fixing support 98, positioning of the power cord 977 is facilitated.

As shown in FIG. 1 and FIG. 2, in some embodiments, the fixing support 98 has a notch 981 in communication with the cord-fixing groove 9722. The power cord 977 is adapted to be inserted into the cord-fixing groove 9722 through the notch 981. By configuring the notch 981 to be in communication with the cord-fixing groove 9722, the power cord 977 can be easily inserted into the cord-fixing groove 9722. The power cord 977 may be wrapped around the fixing support 98, or the power cord 977 may be stably connected to the cord-fixing groove 9722 through interference fit.

As shown in FIG. 1 and FIG. 2, in some embodiments, the notch 981 has a guide surface 9811 extending obliquely towards an interior of the cord-fixing groove 9722. By configuring the guide surface 9811 to guide the power cord 977, the power cord 977 can be easily inserted into the cord-fixing groove 9722.

As shown in FIG. 1 and FIG. 2, in some embodiments, a plurality of fixing supports 98 are provided and arranged at intervals in a length direction of the mounting plate 972. By providing the plurality of fixing supports 98, positioning of a relatively long power cord 977 is facilitated.

For example, two fixing supports 98 are arranged at intervals in the length direction of the mounting plate 972; or three fixing supports 98 are arranged at intervals in the length direction of the mounting plate 972.

As shown in FIG. 1 and FIG. 2, in some embodiments, the mounting plate 972 has a cord passage hole 9721 for the power cord 977. The cord passage hole 9721 is formed at an end of the mounting plate 972 in the length direction of the mounting plate 972, and the plurality of fixing supports 98 are sequentially arranged in a direction away from the mounting hole. Since the cord passage hole 9721 is formed at the end of the mounting plate 972 in the length direction of the mounting plate 972, and the plurality of fixing supports 98 are arranged sequentially in the direction away from the mounting hole, the power cord 977 is positioned on the fixing support 98 towards one side, which is simple and convenient.

In some other embodiments, the plurality of fixing supports 98 are arranged at two sides of the cord passage hole 9721, allowing the power cord 977 to be positioned at the fixing support 98 towards two sides.

In some embodiments, the mounting plate 972 has a first mounting groove and a second mounting groove. The first mounting groove has a different opening direction from the second mounting groove.

The fixing support 98 is provided with a first mounting portion and a second mounting portion. The first mounting portion extends into the first mounting groove, and the second mounting portion extends into the second mounting groove. Through the engagement between the first mounting portion and the first mounting groove as well as the engagement between the second mounting portion and the second mounting groove, the first mounting groove having the different direction from the second mounting groove, the structure is simple while the fixing support 98 is stably positioned on the mounting plate 972.

In some embodiments, an opening of the first mounting groove faces rearwards, and an opening of the second mounting groove faces upwards. By configuring the opening of the first mounting groove to face rearwards and the opening of the second mounting groove to face upwards, the first mounting portion is inserted into the first mounting groove from the rear, and the second mounting portion is inserted into the second mounting groove from above. The first mounting portion and the second mounting portion are subjected to forces in different directions, and the fixing support 98 is thus relatively stably fixed to the mounting plate 972.

Some embodiments of the shell assembly of the present disclosure are described below with reference to FIG. 1 and FIG. 2.

The shell assembly includes a shell 90 and a fixing support 98.

The shell 90 includes a top plate 973, a rear plate 974, a left side plate, a right side plate, and a mounting plate 972.

The mounting plate 972 is formed as a flat plate extending obliquely downwards. An upper edge of the mounting plate 972 is connected to the top plate 973, and a lower edge of the mounting plate 972 is connected to the rear plate 974. A left end of the mounting plate 972 is connected to the left side plate, and a right end of the mounting plate 972 is connected to the right side plate. The mounting plate 972 has a cord passage hole 9721 for the power cord 977, and the cord passage hole 9721 is located at an end of the mounting plate 972 in a length direction of the mounting plate 972. The mounting plate 972 has a first mounting groove and a second mounting groove. An opening of the first mounting groove faces backwards, and an opening of the second mounting groove faces upwards.

Two fixing supports 98 are provided, and the two fixing supports 98 are located at a right side of the cord passage hole 9721 and are spaced apart from each other in a left-right direction. Each of the two fixing supports 98 is provided with a first mounting portion and a second mounting portion. The first mounting portion extends into the first mounting groove, and the second mounting portion extends into the second mounting groove. Each of the two fixing supports 98 has a cord-fixing groove 9722 and a notch 981. The notch 981 is in communication with the cord-fixing groove 9722. The power cord 977 is adapted to be inserted into the cord-fixing groove 9722 through the notch 981. The notch 981 has a guide surface 9811 extending obliquely towards an interior of the cord-fixing groove 9722.

A cooking apparatus 100 according to embodiments of the present disclosure includes the shell assembly for the cooking apparatus described above.

For the cooking apparatus 100 according to the embodiments of the present disclosure, by providing the above-mentioned shell assembly, the shell assembly can fit flush against the inner surface of the cabinet, thereby improving the space utilization rate. Meanwhile, the volume of the receiving space 971 is increased, and the receiving space 971 can thus receive more devices or food.

In some embodiments, the shell 90 has a food access opening 15, and the cooking apparatus 100 further includes a drawer assembly 60. A food carrying space is formed in the drawer assembly 60, and the drawer assembly 60 is drawably disposed in the receiving space 971 through the food access opening 15.

As shown in FIG. 3, for the cooking apparatus 100 according to the embodiments of the present disclosure, the cooking apparatus 100 includes a shell 90, an inner container 10, a guide channel 4221, an air duct member 22, a microwave assembly 42, and a first fan 32.

The shell 90 has a food access opening 15 at a front side of the shell 90.

The inner container 10 has a cooking space 11 and is disposed in the shell 90. The inner container 10 has an air inlet region 12, an air return region 13, and a microwave inlet 14 on a top wall of the inner container 10. At least part of the microwave inlet 14 directly faces the air inlet region 12 in a left-right direction.

The cooking space 11 is configured to place food. The cooking apparatus 100 is configured to cook the food. The food is placed or accessed through the food access opening 15 on the shell 90.

Air outside the inner container 10 flows into the inner container 10 through the air inlet region 12, and air inside the inner container 10 is discharged through the air return region 13. For example, the air inlet region 12 is a region where a plurality of pore structures are located, and the air return region 13 is a region where a plurality of pore structures are located.

The at least part of the microwave inlet 14 directly faces the air inlet region 12 in the left-right direction. That is, in the left-right direction, the microwave inlet 14 may partially or entirely face the air inlet region 12.

The guide channel 4221 is disposed between the top wall of the inner container 10 and the shell 90 and has an end connected to the microwave inlet 14.

The air duct member 22 is disposed between the top wall of the inner container 10 and the shell 90. An air duct space 21 is defined between the air duct member 22 and the top wall of the inner container 10. The air inlet region 12 and the air return region 13 are located in the air duct space 21.

The microwave assembly 42 is disposed between the shell 90 and the inner container 10 and is configured to generate a microwave towards the guide channel 4221. The guide channel 4221 performs a guiding function to guide the microwave generated by the microwave assembly 42 to the microwave inlet 14, and the microwave enters the cooking space 11 through the microwave inlet 14. The microwave causes resonance of molecules inside the food, and mutual friction between the molecules generates heat.

The first fan 32 is located in the air duct space 21.

Specifically, the air inside the air duct space 21 is disturbed by the first fan 32 disposed in the air duct space 21 to form a flowing airflow. The airflow flows into the cooking space 11 from the air duct space 21 through the air inlet region 12, and flows into the air duct space 21 from the cooking space 11 through the air return region 13.

The at least part of the microwave inlet 14 directly faces the air inlet region 12. The positional relationship between the microwave inlet 14 and the air inlet region 12 ensures that a distance between the microwave inlet 14 and the food and a distance between the air inlet region 12 and the food are equal. The flowing air and the microwave contact the food synchronously, thereby improving a cooking effect. The equality of the distances between the microwave inlet 14 and the food and between the air inlet region 12 and the food does not mean absolute sameness, and proximity of the two distances can also achieve the same effect.

A temperature of the food rises under an action of the microwave, and heat of the food is more uniformly distributed in the cooking space 11 by means of the airflow generated by the disturbance of the first fan 32. As a result, the food is heated more uniformly.

For the cooking apparatus 100 according to the embodiments of the present disclosure, since the at least part of the microwave inlet 14 directly faces the air inlet region 12, the distance between the microwave inlet 14 and the food and the distance between the air inlet region 12 and the food are equal or approximate, thereby improving the cooking effect.

Specifically, the cooking apparatus 100 is any one of an air fryer, a microwave oven, and an oven.

As shown in FIG. 3, in some embodiments, in a front-rear direction, the air return region 13 is located at a rear side of the microwave inlet 14, and a part of the air inlet region 12 is located at a front side of the microwave inlet 14. Since in the front-rear direction, the air return region 13 is located at the rear side of the microwave inlet 14, and the part of the air inlet region 12 is located at the front side of the microwave inlet 14, the air flowing into the cooking space 11 through the air inlet region 12 and the microwave contact the food synchronously. Since the air return region 13 is located at the rear side of the microwave inlet 14, influence of the air flowing out of the cooking space 11 on the food can be reduced.

The air return region 13 is located at the rear side of the microwave inlet 14 in the front-rear direction. That is, the air return region 13 does not correspond to the microwave inlet 14 in the left-right direction to prevent airflow in different directions from interfering with the heating effect of the microwave.

As shown in FIG. 3, in some embodiments, a part of the air inlet region 12 is located at the rear side of the microwave inlet 14. By providing the part of the air inlet region 12 to be located at the rear side of the microwave inlet 14, that is, in the left-right direction, not only does the part of the air inlet region 12 correspond to the microwave inlet 14, but also another part of the air inlet region 12 is located at the rear side of the microwave inlet 14 and does not correspond to the microwave inlet 14. Thus, air flowing into the cooking space 11 from the air inlet region 12 covers a microwave influence range. Therefore, the air flowing into the cooking space 11 is more synchronous with the microwave, thereby improving the cooking effect on the food.

In some embodiments, a plurality of air inlet regions 12 are provided.

As shown in FIG. 3 and FIG. 6, in some embodiments, a plurality of air inlet regions 12 are arranged at intervals in the front-rear direction. By arranging the plurality of air inlet regions 12 in the front-rear direction, the influence range is expanded in the front-rear direction.

For example, two air inlet regions 12 are arranged in a front-rear direction; or three air inlet regions 12 are arranged in the front-rear direction; or four air inlet regions 12 are arranged in the front-rear direction.

In some other embodiments, in the left-right direction, the plurality of air inlet regions 12 are arranged at intervals in the left-right direction. By arranging the plurality of air inlet regions 12 in the left-right direction, the influence range is expanded in the left-right direction.

For example, two air inlet regions 12 are spaced apart from each other in the left-right direction; or three air inlet regions 12 are arranged at intervals in the left-right direction; or four air inlet regions 12 are arranged at intervals in the left-right direction.

In some embodiments, opening areas of the plurality of air inlet regions 12 are different. By setting the opening areas of the plurality of air inlet regions 12 to be different, air inlet rates at different positions of the inner space of the inner container 10 are correspondingly different, which adaptively meets needs of food cooking, thereby improving an energy utilization rate.

For example, an opening area of an air inlet region 12 of the plurality of air inlet regions 12 close to a center of the inner space of the inner container 10 is larger than an opening area of an air inlet region 12 of the plurality of air inlet regions 12 far away from the center of the inner space of the inner container 10, which improves the energy utilization rate.

As shown in FIG. 8, in some embodiments, an opening area of an air inlet region 12 of the plurality of air inlet regions 12 closest to the air return region 13 is the largest. By setting the opening area of the air inlet region 12 of the plurality of air inlet regions 12 closest to the air return region 13 to be the largest, most of the heat is fully returned to the internal space of the inner container 10, thereby further improving the energy utilization rate.

For example, the air inlet region 12 is a region where a plurality of pore structures are located, and the opening area of the air inlet region 12 is a total area of the plurality of pore structures. Setting a relatively large total area can increase the flow rate.

As shown in FIG. 8, in some embodiments, a length direction of at least one air inlet region 12 extends in the front-rear direction. With the length direction of the at least one air inlet region 12 extending in the front-rear direction, the airflow is allowed to fully flow in the front-rear direction to allow for thermal uniformity in the internal space of the inner container 10.

As shown in FIG. 10 and FIG. 11, in some embodiments, the air duct space 21 has a first part 211 and a second part 212. The first part 211 and the second part 212 intersect each other. The part of the air inlet region 12 and the air return region 13 are located in the first part 211, and the other part of the air inlet region 12 is located in the second part 212. Since the part of the air inlet region 12 and the air return region 13 are located in the first part 211, and the other part of the air inlet region 12 is located in the second part 212, and the first part 211 and the second part 212 intersect each other, the airflow is prevented from merely disturbing within a linear space, thereby expanding the influence range.

As shown in FIG. 10 and FIG. 11, in some embodiments, the first part 211 and the second part 212 are perpendicular to each other.

As shown in FIG. 10 and FIG. 11, in some embodiments, the first part 211 has a length greater than a length of the second part 212. By setting the length of the first part 211 to be greater than the length of the second part 212, needs of different spaces can be fully satisfied, thereby improving the utilization rate.

As shown in FIG. 8, FIG. 10, and FIG. 11, in some embodiments, the front side of the second part 212 extends to a front of the top wall of the inner container 10. By providing the front side of the second part 212 to extend to the front of the top wall of the inner container 10, an influence range of the second part 212 is enlarged to avoid an airflow dead zone.

As shown in FIG. 4 and FIG. 8, in some embodiments, the first fan 32 directly facing the air return region 13 to guide the air in the inner container 10 into the air duct space 21 from the air return region 13. With the first fan 32 directly facing the air return region 13, the air in the inner container 10 is guided into the air duct space 21 from the air return region 13, thereby expanding the influence range of the first fan 32 on the inner container 10. As a result, an effect of the first fan 32 can be fully exerted.

In some embodiments, the first fan 32 is a centrifugal fan. The centrifugal fan is disposed opposite to the air return region 13. Air from the inner container 10 is drawn by the centrifugal fan to form an airflow, thereby enhancing the influence on the inner container 10. It can be understood that the centrifugal fan has an air inlet end directly facing the air return region 13, thereby drawing the air in the inner container 10.

In some other embodiments, the first fan 32 is disposed between the air return region 13 and the air inlet region 12 to guide the air in the inner container 10 into the air duct space 21 from the air return region 13.

In some embodiments, the first fan 32 is an axial flow fan. The axial flow fan is disposed between the air return region 13 and the air inlet region 12 to allow the airflow to flow in one direction in the air duct space 21 to draw the air from the inner container 10.

As shown in FIG. 13 and FIG. 14, in some embodiments, the cooking apparatus 100 further includes a second fan 50 located in the cooking space 11. The second fan 50 is located below the microwave inlet 14. The second fan 50 is disposed below the microwave inlet 14 and exerts a microwave stirring effect, making the microwaves in the cooking space 11 more uniform, and thereby improving uniformity of cooking.

In some embodiments, the second fan 50 is configured as a metallic member.

As shown in FIG. 14, the second fan 50 is connected to a stirring motor 51. The stirring motor 51 has an output end extending through the microwave assembly 42 and connected to the second fan 50 to drive the second fan 50 to rotate.

In some embodiments, the stirring motor 51 and the first fan 32 overlap in a first direction. By providing the stirring motor 51 and the first fan 32 to overlap in the first direction, the structure is compact. For example, the first direction is an up-down direction.

In some embodiments, both the microwave assembly 42 and the first fan 32 are located at the top wall of the inner container 10.

That is, the microwave inlet 14 is located at the top wall of the inner container 10, which simplifies a process of the inner container 10. For example, there is no need to fix a ceramic plate at the inner container 10, which optimizes process types.

In some embodiments, the inner container 10 is provided with a splash guard at the top wall of the inner container 10. The splash guard corresponds to the microwave inlet 14 to prevent oil from splashing into the microwave inlet 14.

In some embodiments, the splash guard and the top wall of the inner container 10 jointly define a stirring space, and the second fan 50 is located in the stirring space. The splash guard prevents the oil from splashing into the microwave inlet 14 and prevents the oil from splashing on the second fan 50, reducing a workload of later cleaning.

In some embodiments, the splash guard is made of quartz. The microwaves can penetrate the quartz, thereby exerting a splash prevention effect by utilizing the inherent characteristics of the quartz material.

In some embodiments, the microwave assembly 42 includes a microwave generator and a waveguide. The microwave generator is located at the rear side of the inner container 10. The guide channel and the waveguide are integrally formed. The waveguide is engaged with the microwave generator, and the microwave generator extends into the guide channel.

As shown in FIG. 12 to FIG. 15, in some embodiments, the microwave assembly 42 includes a microwave generator 421 and a waveguide 422. The microwave generator 421 is located at the rear side of the inner container 10. The waveguide 422 is engaged with the microwave generator 421, and the waveguide 422 extends into the guide channel 4221. The microwave generator 421 is configured to generate the microwaves for heating the food. Meanwhile, the microwave generator 421 is disposed at the rear side of the inner container 10 to fully utilize spaces of various parts.

In some embodiments, the microwave assembly 42 further includes a tubular metallic member 43. An inner cavity of the tubular metallic member 43 is configured as the guide channel 4221, and the waveguide 422 extends into the guide channel 4221.

In some embodiments, an airflow channel 99 is defined between the shell 90 and the outer side wall of the inner container 10. The airflow channel 99 includes a top airflow passage 92 and a rear airflow passage 95. The waveguide 422 is located in the top airflow passage 92, and the microwave generator 421 (magnetron) is located in the rear airflow passage 95.

In the present disclosure, by disposing the waveguide 422 in the top airflow passage 92, a top side space is fully utilized, making the overall structure of the cooking apparatus 100 thinner in the height direction. Meanwhile, by disposing the microwave generator 421 in the rear airflow passage 95, the spaces of the various parts are rationally utilized.

As shown in FIG. 10 and FIG. 11, in some embodiments, the air duct space 21 includes a plurality of subspaces 213 arranged at intervals. Each of the plurality of subspaces 213 is in communication with the cooking space 11 via the air inlet region 12 and the air return region 13. The first fan 32 is disposed in each of the plurality of subspaces 213, and the microwave inlet 14 directly faces the air inlet region 12 corresponding to at least one of the plurality of subspaces 213. By providing the microwave inlet 14 to directly face an air inlet region 12 corresponding to the at least one of the plurality of subspaces 213, air in the at least one of the plurality of subspaces 213 can contact the food synchronously with the microwave, thereby improving the cooking effect.

The microwave inlet 14 directly faces the air inlet region 12 corresponding to at least one of the plurality of subspaces 213. That is, the microwave inlet 14 may directly face an air inlet region 12 corresponding to one of the plurality of subspaces 213, or may directly face air inlet regions 12 corresponding to some of the plurality of subspaces 213, or may directly face air inlet regions 12 corresponding to all of the plurality of subspaces 213.

In some embodiments, the microwave inlet 14 directly faces an air inlet region 12 corresponding to each subspace 213. By providing the microwave inlet 14 to directly face the air inlet region 12 corresponding to each subspace 213, the air in each subspace 213 can contact the food synchronously with the microwave, thereby further improving the cooking effect.

It should be noted that in the related art, a cooking device utilizes a fan to disturb air to form airflow. Typically, the plurality of fans are arranged in one space. The plurality of fans interfere with each other to cause airflow turbulence and waste energy.

In the present disclosure, by arranging the plurality of subspaces 213 at intervals to separate the plurality of first fans 32, the airflow turbulence is alleviated, improving the energy utilization rate, thereby further enhancing a heating effect.

For example, two subspaces 213 are provided, and one first fan 32 is disposed in each of the two subspaces 213, thereby alleviating the airflow turbulence. In some embodiments, two subspaces 213 are provided and configured to separate four first fans 32, and two first fans 32 are disposed in each of the two subspaces 213, which can also alleviate the airflow turbulence. In some embodiments, three subspaces 213 are provided to separate four first fans 32. Two first fans 32 are disposed in one of the three subspaces 213, and one first fan 32 is disposed in each of another two of the three subspaces 213, which can also alleviate the airflow turbulence.

As shown in FIG. 10, in some embodiments, a partition member 23 is disposed in the air duct space 21 to divide the air duct space 21 into the plurality of sub-spaces 213, reducing the number of components and making assembling easier.

In some embodiments, the partition member 23 is made of a thermal insulation material. With the partition member 23 being made of a thermal insulation material, the partition member 23 divides the air duct space 21 into the plurality of sub-spaces 213, while preventing heat conduction between two adjacent subspaces 213, thereby further achieving uniform heating. Furthermore, the air duct member 22 is configured as a thermal insulation member to concentrate the heat more effectively.

As shown in FIG. 8 and FIG. 10, in some embodiments, the partition member 23 is fixed to the air duct member 22. By fixing the partition member 23 to the air duct member 22, assembling of the cooking apparatus 100 is facilitated.

In some other embodiments, the partition member 23 is fixed to the inner container 10 to facilitate positioning.

In some other embodiments, a plurality of air duct members 22 are provided, and the subspace 213 is defined between the air duct members 22 and the inner container 10.

In some embodiments, the plurality of air duct members 22 are arranged at intervals.

As shown in FIG. 3, in some embodiments, the air duct member 22 is provided with a heat shield 221 for thermal insulation.

As shown in FIG. 4 and FIG. 13, in some embodiments, the first fan 32 is connected to a first motor 31. The first motor 31 is connected to the first fan 32 to drive the first fan 32 to rotate. The first fan 32 is located in the subspace 213, and the first motor 31 is located outside the subspace 213. By disposing the first fan 32 in the sub-space 213 and the first motor 31 outside the sub-space 213, the influence on the airflow is avoided. Compared with the related art in which the drive motor is disposed in the air duct space and thus affects flowing of the airflow, the airflow in the sub-space 213 in the present disclosure is smoother.

In some embodiments, the air duct space 21 has an air duct inlet and an air duct outlet. The air duct inlet is in communication with the air return region 13, and the air duct outlet is in communication with the air inlet region 12. It can be understood that the airflow exits the inner container 10 through the air return region 13 and flows into the air duct space 21 through the air duct inlet, and the airflow exits the air duct space 21 through the air duct outlet and flows into the inner container 10 through the air inlet region 12.

As shown in FIG. 3 and FIG. 4, in some embodiments, the shell 90 has an air inlet 93 and an air outlet 91, and an airflow channel 99 is formed between the shell 90 and an outer side wall of the inner container 10. The airflow channel 99 is in communication with each of the air inlet 93 and the air outlet 91. A first air inlet hole 111 is formed in the cooking space 11 and is in communication with the airflow channel 99. The cooking apparatus 100 further includes a third fan 33 located in the airflow channel 99. By providing the first air inlet hole 111 in communication with the first airflow channel, a flow rate of air flowing into the cooking space 11 is increased, and a flow rate of air discharged out of the shell 90 is larger, thereby improving a heat dissipation effect.

It should be noted that for the cooking apparatus to achieve satisfactory cooking of food material, the temperature and humidity in the cooking space need to be maintained within a predetermined range. The excessively high temperature and humidity also cause a poor cooking effect. Therefore, in the present disclosure, the air discharged out of the shell 90 takes away part of water vapor and heat. Thus, the temperature and humidity in the cooking space 11 are maintained within a predetermined range, thereby improving the cooking effect.

In the related art, air in an oven naturally flows out of the oven, resulting in poor heat dissipation effect. In the present disclosure, the first air inlet hole 111 is additionally formed. Therefore, more air flows into the cooking space 11, and the flow rate of the air discharged out of the shell 90 is increased. As a result, the heat dissipation effect can be improved. Meanwhile, by providing the third fan to fully disturb the air, and the flow rate of the air discharged out of the shell 90 is increased, thereby further improving the heat dissipation effect.

In some embodiments, the air duct member 22 is disposed at an outer wall of the inner container 10 and located in the first airflow duct. The air duct space 21 is disposed between the air duct member 22 and the inner container 10. The inner container 10 has the air inlet region 12 and the air return region 13. Each of the air inlet region 12 and the air return region 13 are in communication with the air duct space 21. For example, the air inlet region 12 is a region where a plurality of pore structures are located, and the air return region 13 is a region where a plurality of pore structures are located.

The first fan 32 is disposed in the air duct space 21. The first fan 32 is disposed in the air duct space 21 to disturb the air in the air duct space 21 to form an airflow. The air exits the air duct space 21 from the air inlet region 12 and flows into the inner container 10. The air exits the inner container 10 from the air outlet region and flows into the air duct space 21.

In some embodiments, the first fan is connected to a first motor 31. The first motor 31 is disposed outside the air duct space 21 and connected to the first fan 32.

The first motor 31 is connected to the first fan 32 and drives the first fan 32 to rotate. Meanwhile, the first motor 31 is located outside the air duct space 21, and air flowing in the first airflow duct dissipates heat from the first motor 31.

In some embodiments, the air duct space 21 is configured to guide air to the air inlet region 12 from the air return region 13.

It can be understood that the air is disturbed by the first fan 32 in the air duct space 21 to form the airflow. The airflow flows into the air duct space 21 from the inner container 10 through the air return region 13. The airflow flows in one direction in the air duct space 21. The airflow flows into the inner container 10 from the air duct space 21 through the air inlet region 12. The airflow flows in the inner container 10 and flows into the air duct space 21 through the air return region 13, thereby forming a one-way circulation of the airflow. As a result, heat in the inner container 10 is distributed more uniformly, thereby improving a heating effect of the food.

As shown in FIG. 3 and FIG. 4, in some embodiments, the air inlet 93 is located below the inner container 10, and the air outlet 91 is located above the inner container 10. The airflow channel 99 includes a bottom airflow passage 94, a rear airflow passage 95, and a top airflow passage 92. The bottom airflow passage 94 is located at a bottom of the inner container 10 and in communication with the air inlet 93. An upper end and a lower end of the rear airflow passage 95 are in communication with the top airflow passage 94 and the bottom airflow passage, respectively. The top airflow passage 92 is in communication with the air outlet 91. The third fan 33 is located in the rear airflow passage 95. The air duct member 22 is located in the top airflow passage 92. By providing the bottom airflow passage 94, the rear airflow passage 95, and the top airflow passage 92, the air flows into the cooking apparatus 100 from the air inlet 93, passes through the bottom airflow passage 94, the rear airflow passage 95, and the top airflow passage 92, and is discharged out of the cooking apparatus 100 from the air outlet 91. Thus, heat can be fully dissipated from all parts of the cooking apparatus 100.

For example, the air flows into the bottom airflow passage 94 from the air inlet 93. The air flows in the bottom airflow passage 94 and takes away heat from the bottom structure of the cooking apparatus 100. Then, the air passes through the rear airflow passage 95 and the top airflow passage 92 sequentially, taking away heat from the rear structure and the top structure of the cooking apparatus 100. Finally, the air is discharged out of the cooking apparatus 100 from the air outlet 91, thereby discharging the heat from each structure of the cooking apparatus 100.

As shown in FIG. 3 and FIG. 4, in some embodiments, the inner container 10 has a third air inlet hole 181 formed at a side wall of the inner container 10 provided with the air duct member 22. The third air inlet hole 181 is in communication with the airflow channel 99. By providing the third air inlet hole 181 at the side wall of the inner container 10 where the air duct member 22 is mounted, the airflow flowing in the airflow channel 99 is conveniently used to dissipate heat from the air duct member 22.

As shown in FIG. 9, in some embodiments, the cooking apparatus 100 further includes a first air guide hood 34. The first air guide hood is disposed at the outer side wall of the inner container 10. An air guide channel 341 is formed in the first air guide hood 34. The air guide channel 341 has an inlet in communication with the airflow channel 99. The air guide channel 341 is in communication with the first air inlet hole 111 and the third air inlet hole 181 to guide the air to the first air inlet hole 111 and the third air inlet hole 181, respectively. By configuring the first air guide hood 34 to guide the flowing of the airflow, a flowing direction of the airflow in the airflow channel 99 is more directional, thereby improving utilization efficiency.

The air guide channel 341 is formed in the first air guide hood 34. The inlet of the air guide channel 341 is in communication with the airflow channel 99. The air guide channel 341 is further in communication with each of the first air inlet hole 111 and the third air inlet 181. The airflow in the airflow channel 99 flows into the air guide channel 341 through the inlet of the air guide channel 341, and then is divided into two branches. The airflow is discharged out of the air guide channel 341 from the first air inlet hole 111 and the third air inlet hole 181; the airflow flows into the cooking space 11 from the first air inlet hole 111, and the heat of the air duct member 22 is dissipated by the airflow from the third air inlet hole 181.

As shown in FIG. 6 and FIG. 7, in some embodiments, the third fan 33 has an air outlet end corresponding to the inlet of the air guide channel 341.

In some embodiments, the above microwave generator 421 is located between the first air guide hood 34 and the third fan 33, and the third fan 33 is configured to cool the microwave generator 421.

As shown in FIG. 9, in some embodiments, the first air guide hood 34 includes an air guide bottom plate 342 and an air guide connection plate 343.

The air guide bottom plate 342 is disposed at the outer side wall of the inner container 10, and the air guide connection plate 343 is disposed at the air guide bottom plate 342. An end of the air guide connection plate 343 away from the air guide bottom plate 342 is connected to the side wall of the inner container 10 provided with the air duct member 22. The air guide connection plate 343, the air guide bottom plate 342, and the inner container 10 together define the air guide channel 341.

More specifically, the inner container 10 includes an inner container rear plate 19 and an inner container upper plate 18. The air guide bottom plate 342 is disposed at the inner container rear plate 19. The air guide connection plate 343 is disposed at the air guide bottom plate 342. An end of the air guide connection plate 343 away from the air guide bottom plate 342 is connected to the inner container upper plate 18. The air guide connection plate 343, the air guide bottom plate 342, the inner container upper plate 18, and the inner container rear plate 19 together define the air guide channel 341.

As shown in FIG. 9, in some embodiments, the first air guide hood 34 has an air outlet hole 3431. The air guide channel 341 is in communication with the airflow channel 99 via the air outlet hole 3431.

As shown in FIG. 9, specifically, the air outlet hole 3431 is formed in the air guide connection plate 343.

As shown in FIG. 6 and FIG. 7, in some embodiments, the cooking apparatus 100 further includes a control module 35 configured to control an operating state of the cooking apparatus 100. The control module 35 is located in the rear airflow passage 95. By disposing the control module 35 in the rear airflow passage 95, air flowing in the rear airflow passage 95 is fully utilized to dissipate heat from the control module 35.

As shown in FIG. 6 and FIG. 7, specifically, the cooking apparatus 100 further includes a transformer 351 configured to converting a voltage level. The transformer 351 is located in the rear airflow passage 95. By disposing the transformer 351 in the rear airflow passage 95, the air flowing in the rear airflow passage 95 is fully utilized to dissipate heat from the transformer 351.

It can be understood that a temperature of the control module 35 rises during its operation, and normal operation of the control module 35 is affected by a relatively high temperature. In the present disclosure, the heat of the control module 35 is dissipated by the air flowing in the rear airflow passage 95, eliminating a need for an additional heat dissipation device, thereby reducing the number of components.

As shown in FIG. 12, in some embodiments, the cooking apparatus 100 further includes a guide rail assembly 70 and a drawer assembly 60.

The drawer assembly 60 is configured to receive food, and the guide rail assembly 70 is disposed between the inner container 10 and the shell 90. The guide rail assembly 70 is connected to the drawer assembly 60 to allow the drawer assembly 60 to be drawably disposed in the cooking space 11. The airflow channel 99 further includes a side airflow passage 96 located at each of a left side and a right side of the inner container 10. The guide rail assembly 70 is located in the side airflow passage 96.

With the slidable arrangement of the drawer assembly 60, placement and removal of the food are facilitated in the present disclosure, compared with the solution in the related art in which a food carrying space is fixed inside a cooking appliance.

It should be noted that the slidable engaged configuration between the drawer assembly 60 and the cooking space 11 allows the cooking apparatus 100 to be embedded in a cabinet of furniture and is suitable for different operating environments.

As shown in FIG. 13 and FIG. 12, in some embodiments, the drawer assembly 60 includes a drawer main body 63 and a roller 64. The roller 64 is disposed at a bottom of the drawer main body 63. The roller 64 is adapted to be in rolling contact with a bottom wall of the inner container 10. The roller 64 is configured to assist a movement of the drawer assembly 60.

More specifically, the roller 64 is disposed at an end of the drawer assembly 60 away from an opening of the inner container 10.

As shown in FIG. 12, the drawer main body 63 includes a drawer body 631 and a drawer door 632. The drawer door 632 is connected to the drawer body 631. A food carrying space is located in the drawer body 631. The drawer door 632 is adapted to open or close the opening.

As shown in FIG. 12, in some embodiments, the drawer door 632 is provided with a handle 6321 and a window, and the shell is provided with a control panel. The drawer door 632 is flush with the control panel.

In some embodiments, the drawer assembly 60 is adapted to move into and out of the cooking space 11 in a translational manner and/or a rotational manner.

That is, the drawer assembly 60 may move into and out of the cooking space 11 in the translational manner; or the drawer assembly 60 may move into and out of the cooking space 11 in the rotational manner; or the drawer assembly 60 may move into and out of the cooking space 11 in the translation manner or in the rotational manner.

By providing the guide rail assembly 70 to guide the movement of the drawer assembly 60 into and out of the cooking space 11, the drawer assembly 60 moves more stably.

As shown in FIG. 7 and FIG. 8, in some embodiments, the airflow channel 99 further includes a side airflow passage 96 located at each of a left side and a right side of the inner container 10, and the guide rail assembly 70 is located in the side airflow passage 96. By mounting the guide rail assembly 70 in the side airflow passage 96, heat from the guide rail assembly 70 is dissipated by using the air flowing in the side airflow passage 96, thereby improving reliability of the guide rail assembly 70.

In some embodiments, the airflow channel 99 further includes a side airflow passage 96 located at each of a left side and a right side of the inner container 10, and a plurality of guide rail assemblies 70 are provided. The plurality of guide rail assemblies 70 are located in the side airflow passage 96 and the bottom airflow passage 94. By mounting the plurality of guide rail assemblies 70 in the side airflow passage 96 and the bottom airflow passage 94, heat of the plurality of guide rail assemblies 70 is dissipated by using air flowing in the side airflow passage 96 and the bottom airflow passage 94, thereby improving the reliability of the guide rail assembly 70.

In some embodiments, the guide rail assembly 70 is close to the inner container 10. The inner container 10 is usually at a relatively high temperature during operation of the cooking apparatus 100. The guide rail assembly 70 usually requires lubricating fluid during normal operation. The relatively higher temperature causes the lubricating fluid to be quickly consumed or failed. In the present disclosure, by using the air flowing in the side airflow passage 96 to dissipate the heat from the guide rail assembly 70, the lubricating fluid can consistently function, thereby improving the reliability of the guide rail assembly 70.

As shown in FIG. 12, specifically, the guide rail assembly 70 includes a guide rail 71 and a slider 72. The slider 72 is adapted to slide along the guide rail 71. One of the guide rail 71 and the slider 72 is disposed in the drawer assembly 60, and another one of the guide rail 71 and the slider 72 is disposed in the inner container 10.

As shown in FIG. 8, in some other embodiments, the inner container 10 includes a first side plate 16, a second side plate 161, and a bottom plate 17. The first side plate 16 is disposed at a side of the cooking space 11. The second side plate 161 is disposed at another side of the cooking space 11. The first side plate 16 is connected to the second side plate 161 by the bottom plate 17, and the bottom plate 17 is located at a bottom of the cooking space 11.

As shown in FIG. 12, the guide rail assembly 70 is disposed between a bottom of the drawer assembly 60 and the bottom plate 17. By disposing the guide rail assembly 70 between the bottom of the drawer assembly 60 and the bottom plate 17, the guide rail assembly 70 can fully bear the weight of the drawer assembly 60, thereby reducing a requirement for strength of a connection between the guide rail assembly 70 and the drawer assembly 60.

In some other embodiments, the inner container 10 includes a first side plate 16, a second side plate 161, and a bottom plate 17. The first side plate 16 is disposed at a side of the cooking space 11. The second side plate 161 is disposed at another side of the cooking space 11. The first side plate 16 is connected to the second side plate 161 by the bottom plate 17, and the bottom plate 17 is located at the bottom of the cooking space 11.

As shown in FIG. 12, the guide rail assembly 70 is disposed between a first side of the drawer assembly 60 and the first side plate 16 and between a second side of the drawer assembly 60 and the second side plate 161. Meanwhile, the guide rail assembly 70 is disposed between the bottom of the drawer assembly 60 and the bottom plate 17. By disposing the guide rail assemblies 70 between the first side of the drawer assembly 60 and the first side plate 16, between the second side of the drawer assembly 60 and the second side plate 161, and between the bottom of the drawer assembly 60 and the bottom plate 17, the plurality of guide rail assemblies 70 together support the drawer assembly 60, allowing the drawer assembly 60 to carry more and heavier food.

As shown in FIG. 12, in some embodiments, the cooking apparatus 100 further includes a drawer drive member 80 configured to drive the drawer assembly 60 to move into and out of the cooking space 11. The drawer drive member 80 and the microwave assembly 42 are located at different sides of the inner container 10. By providing the drawer drive member 80 to drive the drawer assembly 60 to move into and out of the cooking space 11, an automation level of the cooking apparatus 100 is improved.

The drawer drive member 80 and the microwave assembly 42 are located at the different sides of the inner container 10 to fully utilize a surrounding space of the inner container 10. For example, the drawer drive member 80 is located at a right side of the inner container 10, and the microwave assembly 42 is located at an upper side of the inner container 10; or the drawer drive member 80 is located at a left side of the inner container 10, and the microwave assembly 42 is located at a lower side of the inner container 10; in some embodiments, the drawer drive member 80 may also be located at other sides of the inner container 10, which is not repeated herein.

In some embodiments, the drawer drive member 80 includes a push-pull motor and a push-pull rod. The push-pull rod is connected to the drawer assembly 60. The push-pull motor is configured to drive the push-pull rod to translate to drive the drawer assembly 60 to move into and out of the cooking space 11.

In some embodiments, an upper end of the side airflow passage 96 is in communication with the top airflow passage 92.

For example, the air flows to the top airflow passage 92 from the side airflow passage 96 and is finally discharged out of the cooking apparatus 100 from the air outlet 91.

As shown in FIG. 13 and FIG. 12, in some embodiments, the cooking apparatus 100 further includes a food carrier 61 disposed in the cooking space 11. The inner container 10 has a microwave inlet 14 corresponding to a center of the food carrier 61. By providing the microwave inlet 14 to correspond to the center of the food carrier 61, the microwave inlet 14 can correspond to the center of the food, thereby improving uniformity of microwave heating.

It should be noted that in the related art, the microwave inlet is located at a center of the cooking space. However, since the cooking space is relatively large, food placed by a user may not always be located at the center of the cooking space, resulting in low uniformity of the microwave heating, uneven heating of different parts of the food, and a poor cooking effect of the food. In the present disclosure, the food carrier 61 is provided to carry the food. For example, the food carrier is a grill, and the microwave inlet 14 corresponds to a center of the grill, thereby improving the uniformity of the microwave heating and improving the cooking effect.

As shown in FIG. 7 and FIG. 16, in some embodiments, the cooking apparatus 100 further includes an air baffle plate 36. The air baffle plate 36 is disposed between the shell 90 and the inner container 10 to separate the bottom airflow passage 94 and at least one side airflow passage 96. The air baffle plate 36 has a second air inlet hole 361 configured to bring the bottom airflow passage 94 into communication with the side airflow passage 96. By providing the air baffle plate 36 to separate the bottom airflow passage 94 and the side airflow passage 96, a boundary between the bottom airflow passage 94 and the side airflow passage 96 is clearer, avoiding the airflow turbulence.

The second air inlet hole 361 is formed at the air baffle plate 36, and the bottom airflow passage 94 is in communication with the side airflow passage 96 via the second air inlet hole 361. Air flows in both the bottom airflow passage 94 and the side airflow passage 96. For example, the bottom airflow passage 94 is in communication with a left airflow passage via the second air inlet hole 361; or the bottom airflow passage 94 is in communication with a right airflow passage via the second air inlet hole 361; or the second air inlet hole 361 is in communication with the bottom airflow passage 94, the left airflow passage, and the right airflow passage.

For example, the air in the bottom airflow passage 94 flows into the side airflow passage 96 through the second air inlet hole 361.

As shown in FIG. 5 to FIG. 8, in some embodiments, the inner container 10 is provided with an inner container rear plate 19. The inner container rear plate 19 cooperates with each of the shell 90 and the air baffle plate 36 to separate the bottom airflow passage 94, the rear airflow passage 95, and the side airflow passage 96. The inner container rear plate 19 has a first communication hole 191 and a second communication hole 192. The bottom airflow passage 94 is in communication with the rear airflow passage 95 via the first communication hole 191, and the side airflow passage 96 is in communication with the rear airflow passage 95 via the second communication hole 192. By providing the inner container rear plate 19 to separate the bottom airflow passage, the rear airflow passage 95, and the side airflow passage 96, a boundary between the passages is clearer, avoiding the airflow turbulence.

The first communication hole 191 is formed in the inner container rear plate 19, the bottom airflow passage 94 is in communication with the rear airflow passage 95 via the first communication hole 191. Therefore, the air in both the bottom airflow passage 94 and the rear airflow passage 95 can flow therebetween. For example, the air in the bottom airflow passage 94 flows into the rear airflow passage 95 through the first communication hole 191.

The second communication hole 192 is formed in the inner container rear plate 19, and the side airflow passage 96 is in communication with the rear airflow passage 95 via the second communication hole 192. Therefore, the air in both the side airflow passage 96 and the rear airflow passage 95 can flow therebetween. For example, the air in the side airflow passage 96 flows into the rear airflow passage 95 through the second communication hole 192.

In some embodiments, the inner container 10 has at least one heat dissipation region 162 in communication with the airflow channel 99. The at least one heat dissipation region 162 is configured to dissipate heat from the cooking space 11 in the inner container 10, and meanwhile, the heat dissipation region 162 is in communication with the airflow channel 99, eliminating a need for an additional channel, thereby improving the utilization rate. In some embodiments, the heat dissipation region 162 and the first air inlet hole 111 are located at different side walls of the inner container 10. With the heat dissipation region 162 and the first air inlet hole 111 located at the different side walls of the inner container 10, an air flowing path is lengthened, allowing more water vapor and heat to be discharged. The heat dissipation region 162 and the first air inlet hole 111 may be located at adjacent side walls of the inner container 10 or may be located at opposite side walls of the inner container 10.

As shown in FIG. 3 to FIG. 6, in some embodiments, the heat dissipation region 162 and the first air inlet hole 111 are located at adjacent side walls of the inner container 10. With the heat dissipation region 162 and the first air inlet hole 111 located at the adjacent side walls of the inner container 10, the air flowing path is lengthened, allowing more water vapor and heat to be discharged.

For example, the first air inlet hole 111 is formed at a rear wall of the inner container 10, and the heat dissipation region 162 is located at a left wall of the inner container 10; or the first air inlet hole 111 is formed at the rear wall of the inner container 10, and the heat dissipation region 162 is located at a right wall of the inner container 10; or the first air inlet hole 111 is formed at the left wall of the inner container 10, and the heat dissipation region 162 is located at the rear wall of the inner container 10; or the first air inlet hole 111 is formed at a right wall of inner container 10, and the heat dissipation region 162 is located at the rear wall of inner container 10; or the first air inlet hole 111 is formed at an upper wall of the inner container 10, and the heat dissipation region 162 is located at the rear wall of inner container 10; or the first air inlet hole 111 is formed at the upper wall of the inner container 10, and the heat dissipation region 162 is located at the left wall of the inner container 10; or the first air inlet hole 111 is formed at the upper wall of the inner container 10, and the heat dissipation region 162 is located at the right wall of the inner container 10; or the first air inlet hole 111 is formed at the rear wall of the inner container 10, and the heat dissipation region 162 is located at the upper wall of the inner container 10; or the first air inlet hole 111 is formed at the left wall of the inner container 10, and the heat dissipation region 162 is located at the upper wall of the inner container 10; or the first air inlet hole 111 is formed at the right wall of the inner container 10, and the heat dissipation region 162 is located at the upper wall of the inner container 10.

In some other embodiments, the heat dissipation region 162 and the first air inlet hole 111 are disposed at opposite side walls of the inner container 10. By disposing the heat dissipation region 162 and the first air inlet hole 111 at the opposite side walls of the inner container 10, the air flowing path is lengthened, allowing more water vapor and heat to be discharged.

For example, the first air inlet hole 111 is formed at the rear wall of the inner container 10, and the heat dissipation region 162 is located at the front wall of the inner container 10; or the first air inlet hole 111 is formed at the left wall of the inner container 10, and the heat dissipation region 162 is located at the right wall of the inner container 10.

In some embodiments, the inner container 10 is provided with a side plate. The heat dissipation region 162 is located at the side plate. The side plate is further provided with a second air guide hood. An end of an inner space of the second air guide hood is in communication with the heat dissipation region 162, and another end of the inner space of the second air guide hood is in communication with the air outlet 91.

As shown in FIG. 3 to FIG. 8, specifically, the airflow channel 99 includes a top airflow passage 92. The top airflow passage 92 is located at a top of the inner container 10 and in communication with the air outlet 91. The inner container 10 has a fourth air inlet hole 182 configured to bring the top airflow passage 92 into communication with the inner space of the second air guide hood.

For example, the inner container 10 is provided with an inner container upper plate 18, and the fourth air inlet hole 182 is formed at the inner container upper plate 18.

As shown in FIG. 3 and FIG. 14, in some embodiments, the cooking apparatus 100 further includes a heating tube 41 disposed in the cooking space 11. The heating tube 41 and the microwave assembly 42 are configured to heat the food. A variety of different heating modes enhance applicability.

Infrared rays are emitted by the heating tube 41 to heat the food. Microwaves are emitted by the microwave assembly 42, which cause molecules inside the food to resonate and thus rub against each other to generate heat.

In some embodiments, the microwave assembly 42 and the first fan 32 are located at one side of the inner container 10. By providing the microwave assembly 42 and the first fan 32 at one side of the inner container 10, a smaller space is occupied, making the overall structure of the cooking apparatus 100 more compact.

In the related art, a fan device and a microwave generator are mounted on an upper side and a lower side of a cavity, respectively. In order to mount the fan device, a full-layer receiving space has to be provided above the cavity. In order to mount the microwave generator, a full-layer receiving space has to be provided below the cavity. Meanwhile, when assembling a cooking appliance, the fan device and the microwave generator has to be mounted at the two sides of the cavity, making assembling relatively difficult.

In the present disclosure, the microwave assembly 42 and the first fan 32 are located at one side of the inner container 10, that is, they can only occupy one side of the inner container 10. The functional components of the cooking apparatus 100, such as the microwave assembly 42 and the first fan 32, are more concentrated and compact in structure. Meanwhile, the concentrated functional components are convenient for mounting.

The microwave assembly 42 and the first fan 32 are located at the top of the inner container 10, which simplifies the process of the inner container 10. For example, there is no need to fix a ceramic plate at the inner container 10, which optimize process types.

In some embodiments, the first fan 32 is arranged around the microwave assembly 42. By arranging the first fan 32 around the microwave assembly 42, an influence range of airflow generated by the first fan 32 is larger.

In some embodiments, the cooking apparatus 100 has a first operating mode and a second operating mode. When the cooking apparatus 100 is in the first operating mode, the microwave assembly 42 and the first fan 32 operate. When the cooking apparatus 100 is in the second operating mode, the heating pipe 41 and the first fan 32 operate. That is, the first fan 32 operates in both the first operating mode and the second operating mode, fully utilizing the first fan 32, thereby reducing the number of components.

That is, the cooking apparatus 100 has at least two operating modes, i.e., the first operating mode and the second operating mode.

When the cooking apparatus 100 is in the first operating mode, the microwave assembly 42 and the first fan 32 operate. Microwaves generated by the microwave assembly 42 can heat the food in the cooking space 11. Airflow generated by the operation of the first fan 32 flows over the food, heating the food more uniformly, thereby improving the cooking effect.

A plurality of first fans 32 are provided. The microwave assembly 42 and the first fans 32 operate, that is, the microwave assembly 42 may operate with one first fan 32, two first fans 32, or three first fans 32.

In some embodiments, the microwave assembly 42 and the first fan 32 operate simultaneously. For example, the microwave assembly 42 and the first fan 32 start operating simultaneously, or the microwave assembly 42 and the first fan 32 both operate within a period of time.

In some other embodiments, the microwave assembly 42 and the first fan 32 operate alternately. That is, the microwave assembly 42 operates for a period of time, followed by the first fan 32 operating for a period of time, and then the microwave assembly 42 again operates for a period of time. The first fan 32 makes the heat distribution more uniform.

When the cooking apparatus 100 is in the second operating mode. The heating tube 41 and the first fan 32 operate. Infrared rays are generated by the heating tube 41 to heat the food. Airflow generated by the operation of the first fan 32 flows in the cooking space 11, making a temperature in the cooking space 11 more uniform, thereby improving heating uniformity.

A plurality of first fans 32 are provided. The heating pipe 41 and the first fan 32 operate, that is, the heating pipe 41 can operate with one first fan 32, two first fans 32, or three first fans 32.

In some embodiments, the heating pipe 41 and the first fan 32 operate simultaneously. For example, the heating pipe 41 and the first fan 32 start operating simultaneously, or the heating pipe 41 and the first fan 32 both operate within a period of time.

In some other embodiments, the heating pipe 41 and the first fan 32 operate alternately. That is, the heating pipe 41 operates for a period of time, followed by the first fan 32 operating for a period of time, and then the heating pipe 41 again operates for a period of time. The first fan 32 makes a heat distribution more uniform.

In some embodiments, the cooking apparatus 100 is configured as a built-in cooking apparatus. By configuring the cooking apparatus 100 as the built-in cooking apparatus, an aesthetic appearance is improved. For example, the built-in cooking apparatus is embedded in a cabinet.

Some embodiments of a cooking apparatus 100 of the present disclosure are described below with reference to FIG. 3 to FIG. 17.

A cooking apparatus 100 includes a shell 90, an inner container 10, an air duct member 22, a first fan 32, a first motor 31, a microwave assembly 42, a microwave generator 421 (a heating tube), a drawer assembly 60, and a guide rail assembly 70.

The shell 90 has an air inlet 93, an air outlet 91, and a food access opening 15 that are located at a front surface of the shell 90.

The inner container 10 is disposed in the shell 90 and has a cooking space 11. The inner container 10 includes a bottom plate 17, an inner container upper plate 18, an inner container rear plate 19, a first side plate 16, and a second side plate 161. The first side plate 16 has a heat dissipation region 162 at an upper part of the first side plate 16, and the heat dissipation region 162 is in communication with the air outlet 91.

The inner container upper plate 18 has four air inlet regions 12, two air return region 13, and a microwave inlet 14. A part of the microwave inlet 14 directly faces the two air inlet regions 12 in a left-right direction. The air return region 13 is located at a rear side of the microwave inlet 14 in a front-rear direction.

An air duct space 21 is formed between the air duct member 22 and the inner container upper plate 18. A partition member 23 is disposed in the air duct space 21 to divide the air duct space 21 into two sub-spaces 213. Each of the two sub-spaces 213 corresponds to two air inlet regions 12 and one air return region 13. Length directions of the two air inlet regions 12 corresponding to each of the two sub-spaces 213 are perpendicular to each other. The air duct member 22 is provided with a heat shield 221 at a side of the air duct member 22 away from the inner container upper plate 18. The partition member 23 is made of a thermal insulation material.

Two first fans 32 are provided and correspond to two sub-spaces 213. The first motor 31 is connected to the first fan 32 to drive the first fan 32 to rotate. The first fan 32 is located in the sub-space 213, and the first motor 31 is located outside the sub-space 213. The first fan 32 corresponds to the air return region 13.

The heating pipe 41 is disposed in the cooking space 11.

The microwave assembly 42 includes a microwave generator 421 and a waveguide 422. The microwave generator 421 is configured to generate a microwave, and the microwave enters the cooking space 11 through the waveguide 422 and the microwave inlet 14. A rotatable second fan 50 is correspondingly disposed at the microwave inlet 14. A stirring motor 51 is disposed at a side of the waveguide 422 away from the microwave inlet 14. The stirring motor 51 is connected to the second fan 50 to drive the second fan 50.

The drawer assembly 60 is in sliding fit with the inner container 10 through the food access opening 15. The drawer assembly 60 includes a drawer main body 63 and a roller 64. The roller 64 is located at a bottom of the drawer main body 63. The roller 64 is adapted to be in rolling contact with a bottom wall of the inner container 10. The roller 64 is configured to assist a movement of the drawer main body 63. The drawer main body 63 includes a drawer body 631 and a drawer door 632. The drawer door 632 is connected to the drawer body 631. The drawer body 631 has a food carrying space. The drawer door 632 is adapted to open or close the food access opening 15.

Three guide rail assemblies 70 are provided and respectively disposed at a first side plate 16, a second side plate 161, and a bottom plate 17. Each of the three guide rail assemblies 70 includes a guide rail 71 and a slider 72. The guide rail 71 is disposed at the inner container 10, and the slider 72 is connected to the drawer door 632. The second side plate 161 is provided with a drawer drive member 80. The drawer drive member 80 includes a push-pull motor and a push-pull rod. The push-pull rod is connected to the drawer assembly 60, and the push-pull motor is configured to drive the push-pull rod to move.

An airflow channel 99 is formed between the shell 90 and an outer side wall of the inner container 10. The airflow channel 99 includes a bottom airflow passage 94, a rear airflow passage 95, a top airflow passage 92, and a side airflow passage 96.

The bottom airflow passage 94 is formed between the bottom plate 17 and the shell 90. A front end of the bottom airflow passage 94 is in communication with the air inlet 93. One of the three guide rail assemblies 70 is disposed in the bottom airflow passage 94.

The rear airflow passage 95 is formed between the inner container rear plate 19 and the shell 90. The rear airflow passage 95 is in communication with the bottom airflow passage 94 via a first communication hole 191 formed at the inner container rear plate 19. A third fan 33, a control module 35, and a microwave generator 421 are disposed in the rear airflow passage 95. A first air guide hood 34 is disposed on the inner container rear plate 19. An air guide channel 341 is formed in the first air guide hood 34. The air guide channel 341 has an inlet in communication with the rear airflow passage 95. The air guide channel 341 is in communication with a first air inlet hole 111 and a third air inlet hole 181 to guide air to a cooking space 11 and the top airflow passage 92.

The top airflow passage 92 is formed between the inner container upper plate 18 and the shell 90 and in communication with the air outlet 91. The first fan and the waveguide 422 are located in the top airflow passage 92.

The side airflow passages 96 include a left airflow passage and a right airflow passage.

An air baffle plate 36 is configured to define the left airflow passage. The left airflow passage is in communication with the bottom airflow passage 94 via a second air inlet hole 361 formed at the air baffle plate 36. An end of the left airflow passage is in communication with the rear airflow passage 95 via a second communication hole 192 formed at the inner container rear plate 19. One of the three guide rail assemblies 70 is disposed in the left airflow passage. The second air guide hood is disposed in the left airflow passage. A space in the second air guide hood is in communication with a heat dissipation region 162 on a side plate and a fourth air inlet hole 182 on the inner container upper plate 18. The fourth air inlet hole 182 is in communication with the top airflow passage 92.

The right airflow passage is disposed between the side plate and the shell 90. An end of the right airflow passage is in communication with the rear airflow passage 95. The right airflow passage is in communication with the top airflow passage 92 via a hole formed at the inner container upper plate 18. One of the three guide rail assemblies 70 is disposed in the right airflow passage, and the drawer driver 80 is disposed in the right airflow passage.

A cooking system according to embodiments of the present disclosure includes the above-mentioned cooking apparatus 100 and a cabinet.

The cabinet has an accommodation cavity for accommodating the cooking apparatus 100.

For the cooking system according to the embodiments of the present disclosure, by providing the mounting plate 972 that extends obliquely downwards, the shell assembly can fit flush against the inner surface of the cabinet, thereby improving the space utilization rate. Meanwhile, the volume of the receiving space 971 is expanded, and the receiving space 971 can thus receive more devices or food.

Other compositions and operations of the shell assembly according to the embodiments of the present disclosure are known to those of ordinary skill in the art, and details thereof will be omitted herein.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations illustrated in the drawings, and for describing the present disclosure and for describing in simple, and which are not intended to indicate or imply that the device or the elements are disposed to locate at the specific directions or are structured and performed in the specific directions, which could not to be understood to the limitation of the present disclosure.

Furthermore, the feature defined with “first” and “second” may include one or more this feature distinctly or implicitly, which is used to distinguish and describe features without any order of sequence or priority of importance.

In the description of the present disclosure, “a plurality of” means two or more than two, unless specified otherwise.

In the description of the embodiments of the present disclosure, it should be noted that, unless otherwise clearly specified and limited, terms such as “installed”, “connected”, “connected to” and the like should be understood in a broad sense. For example, it may be a fixed connection or a detachable connection or connection as one piece; mechanical connection or electrical connection; direct connection or indirect connection through an intermediate; internal communication of two components. For those skilled in the art, the specific meaning of the above-mentioned terms in the embodiments of the present disclosure can be understood according to specific circumstances.

In the description of this specification, descriptions with reference to the terms “an embodiment”, “an example”, etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A shell assembly for a cooking apparatus, the shell assembly comprising:
a shell defining a receiving space and comprising a top plate and a mounting plate, wherein the mounting plate extends obliquely downwards relative to a first plane where the top plate is located, and wherein the mounting plate has a cord-fixing groove for receiving a power cord.

2. The shell assembly for the cooking apparatus according to claim 1, wherein the shell further comprises a rear plate directly facing an opening of the receiving space, the mounting plate being connected between the top plate and the rear plate.

3. The shell assembly for the cooking apparatus according to claim 2, wherein the shell further comprises a left side plate and a right side plate, two ends of the mounting plate being connected to the left side plate and the right side plate, respectively.

4. The shell assembly for the cooking apparatus according to claim 1, wherein the mounting plate is formed as a flat plate extending obliquely downwards.

5. The shell assembly for the cooking apparatus according to claim 1, further comprising a fixing support mounted to the mounting plate, the cord-fixing groove being formed in the fixing support.

6. The shell assembly for the cooking apparatus according to claim 5, wherein the fixing support has a notch in communication with the cord-fixing groove, the power cord being adapted to be inserted into the cord-fixing groove through the notch.

7. The shell assembly for the cooking apparatus according to claim 6, wherein the notch has a guide surface extending obliquely towards an interior of the cord-fixing groove.

8. The shell assembly for the cooking apparatus according to claim 5, wherein a plurality of fixing supports are provided and arranged at intervals in a length direction of the mounting plate.

9. The shell assembly for the cooking apparatus according to claim 8, wherein the mounting plate has a cord passage hole for the power cord, the cord passage hole being formed at an end of the mounting plate in the length direction of the mounting plate, and the plurality of fixing supports being sequentially arranged in a direction away from the cord passage hole.

10. The shell assembly for the cooking apparatus according to claim 5, wherein:
the mounting plate has a first mounting groove and a second mounting groove, the first mounting groove having a different opening direction from the second mounting groove; and
the fixing support is provided with a first mounting portion and a second mounting portion, the first mounting portion extending into the first mounting groove, and the second mounting portion extending into the second mounting groove.

11. The shell assembly for the cooking apparatus according to claim 10, wherein:
an opening of the first mounting groove faces rearwards; and
an opening of the second mounting groove faces upwards.

12. A cooking apparatus, comprising the shell assembly for the cooking apparatus according to any one of claim 1.

13. The cooking apparatus according to claim 12, wherein:
the shell has a food access opening; and
the cooking apparatus further comprises a drawer assembly, a food carrying space being formed in the drawer assembly, and the drawer assembly being drawably disposed in the receiving space through the food access opening.

14. The cooking apparatus according to claim 12, further comprising an inner container having a cooking space, wherein:
the shell has an air inlet and an air outlet;
an airflow channel is formed between the shell and an outer side wall of the inner container, the airflow channel being in communication with each of the air inlet and the air outlet; and
the cooking space has a first air inlet hole in communication with the airflow channel; and
wherein the cooking apparatus further comprises a third fan located within the airflow channel.

15. The cooking apparatus according to claim 14, wherein:
the inner container has an air inlet region, a return air region, and a microwave inlet on a top wall of the inner container, at least part of the microwave inlet directly facing the air inlet region in a left-right direction; and
the cooking apparatus further comprises:
an air duct member disposed between the top wall of the inner container and the shell, wherein an air duct space is defined between the air duct member and the top wall of the inner container, the air inlet region and the return air region being located in the air duct space; and
a first fan located in the air duct space.

16. The cooking apparatus according to claim 15, wherein:
the air inlet is located below the inner container;
the air outlet is located above the inner container;
the airflow channel comprises a bottom airflow passage, a rear airflow passage, and a top airflow passage, wherein the bottom airflow passage is located at a bottom of the inner container and in communication with the air inlet, wherein an upper end and a lower end of the rear airflow passage are in communication with the top airflow passage and the bottom airflow passage, respectively, wherein the top airflow passage is in communication with the air outlet, wherein the third fan is located in the rear airflow passage, and wherein the air duct member is disposed in the top airflow passage.

17. The cooking apparatus according to claim 12, wherein the cooking apparatus is constructed as a built-in cooking apparatus.

18. A cooking system, comprising:
the cooking apparatus according to claim 12; and
a cabinet having an accommodation cavity for accommodating the cooking apparatus.
